(19) United States
(12) Patent Application Publication
(10) Pub. No.: US 2006/0048981 A1
(43) Pub. Date: Mar. 9, 2006

(54) High output and efficiency internal combustion engine

(76) Inventor: Vitali Nikofayevich Bychkovski, Roseville, MN (US)

Correspondence Address: Vitali N. Bychkovski, 1267 Ryan Ave W, Roseville, MN, 55113, US

(21) Appl. No.: 11/210,090

(22) Filed: Aug. 23, 2005

Related U.S. Application Data
(60) Provisional application No. 60/603,793, filed on Aug. 23, 2004.

(51) Int. Cl. B60K 6/00; F02B 37/00; F02B 69/06

(52) U.S. Cl. 180/65.2; 123/21; 60/605.1

(57) ABSTRACT

A four-stroke internal combustion engine is equipped with variable valve timing, divided exhaust and a supercharger. The engine is optimized for a low power operation, while charging the cylinder with additional air and dynamically switching the engine into a two-stroke cycle mode satisfies high peak power demand.

### CROSS-REFERENCES TO RELATED APPLICATIONS

This application claims the benefit of the filing of U.S. Provisional Patent Application Ser. No. 60/603,793, entitled “High Output and Efficiency Internal Combustion Engine”, filed on Aug. 23, 2004.

### FEDERALLY SPONSORED RESEARCH

None.

### SEQUENCE LISTING

None.

### TECHNICAL FIELD

This invention relates to internal combustion engines, more specifically, to a supercharged internal combustion engine and a method of operation thereof, in which a compressed air and divided exhaust extraction are used to improve the engine's efficiency and output. In particular, the engine is capable of effective residual exhaust gas removal and charging the cylinder with compressed air; and can function in a two-stroke cycle mode.

### THE OBJECT

The object of this invention is to provide an improved engine that is efficient at low load yet is capable of high power output. Another object is to propose a simple and economical design solution.

### SUMMARY

By the present invention, an improved reciprocating piston, four-stroke compression or spark ignition supercharged internal combustion engine is equipped with variable valve timing means (e.g. electromagnetic valve actuation), divided exhaust and direct fuel injection. At idle and partial load the engine operates in a four-stroke mode and may shut-off a number of cylinders to further improve fuel efficiency. Engine speed may be regulated by means of valve timing.

As the power demand exceeds what the engine operating at atmospheric pressure on a four-stroke cycle can supply, the turbocompressor (driven with a gas flow through the first exhaust manifold) pressurizes the intake air. This air is being cooled by a heat exchanger between the compressor and the cylinder. The exhaust back pressure and residual exhaust gas may be removed through a freer flowing (not restricted by the turbine) second exhaust manifold after the valve into the first manifold is closed. Upon continuing power demand the intake pressure is further increased, not necessarily beyond the point essential for a dynamic switch from a four-stroke cycle to a two-stroke cycle. Meanwhile, combustion chamber temperature and detonation may be controlled by means of variable valve timing adjusting the degree of recompression by the piston inside the cylinder.

When the intake air pressure becomes sufficient to displace exhaust in a two-stroke cycle, the engine may be converted, by means of variable valve timing, to a two-stroke mode to further increase power by increasing the number of putts per revolution. Direct injection delivers fuel after exhaust valves are closed. This ensures that there is no unburned combustible mixture blown-through while exhaust gases are being displaced by pressurized intake air.

The intake air density can be further increased until a predetermined peak cylinder pressure or combustion chamber temperature is reached. At this point the excess compressed intake air may be expelled through a blow-off valve and the flow through exhaust driven turbine reduced to decrease the degree of pressurization by the compressor.

When the power demand is reduced, the engine reverses itself from a two-stroke cycle to a four-stroke cycle and may shut-off cylinders at low load. This results in a high output and efficiency engine.

### DRAWINGS

FIG. 1A is a schematic illustration of a prior art supercharged engine.

FIG. 1B is a schematic illustration of a prior art turbocharged engine.

FIG. 2 is a schematic illustration of a present invention. The valve position does not depict an actual camshaft-crankshaft relationship.

FIG. 3A is a Otto cycle valve timing diagram.

FIG. 3B is a Miller cycle valve timing diagram.

FIG. 3C shows schematically 4-stroke valve timing succession and 2-stroke valve timing succession according to present invention.

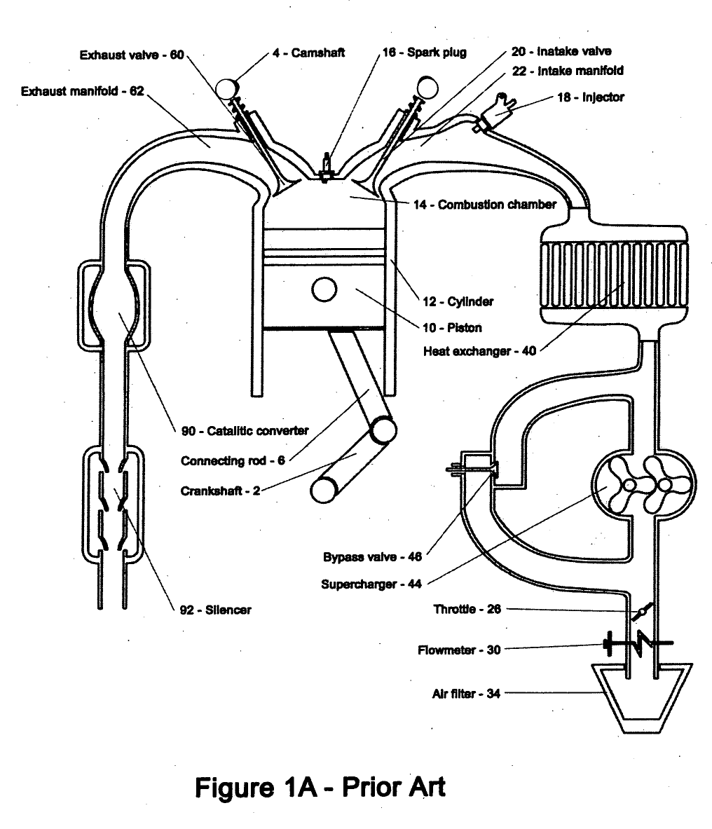

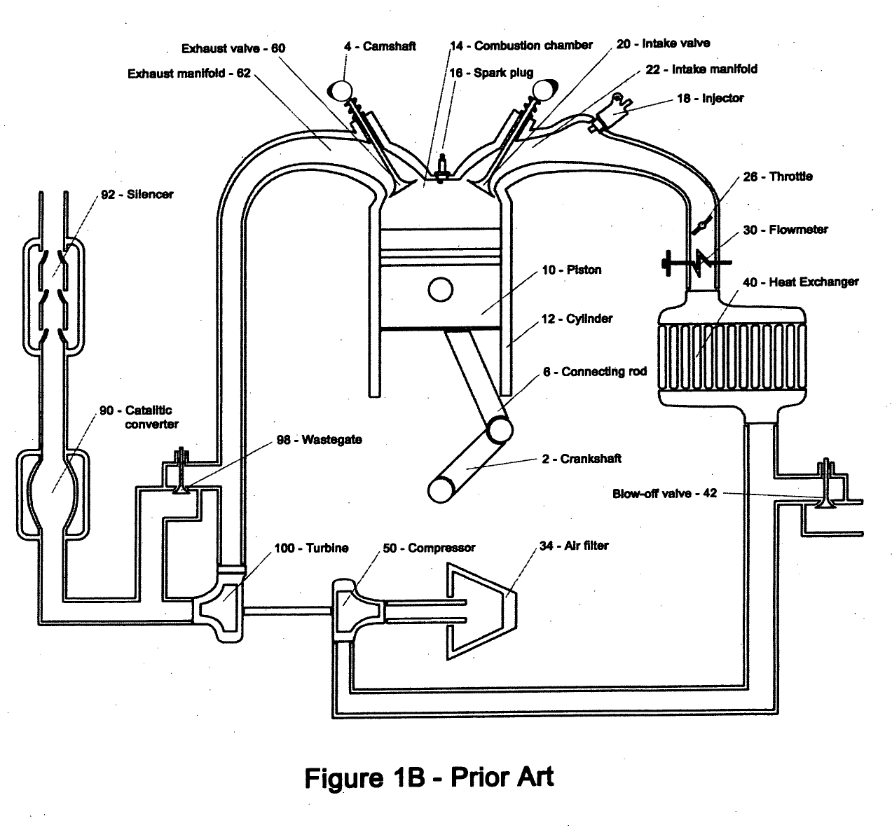

### DETAILED DESCRIPTION

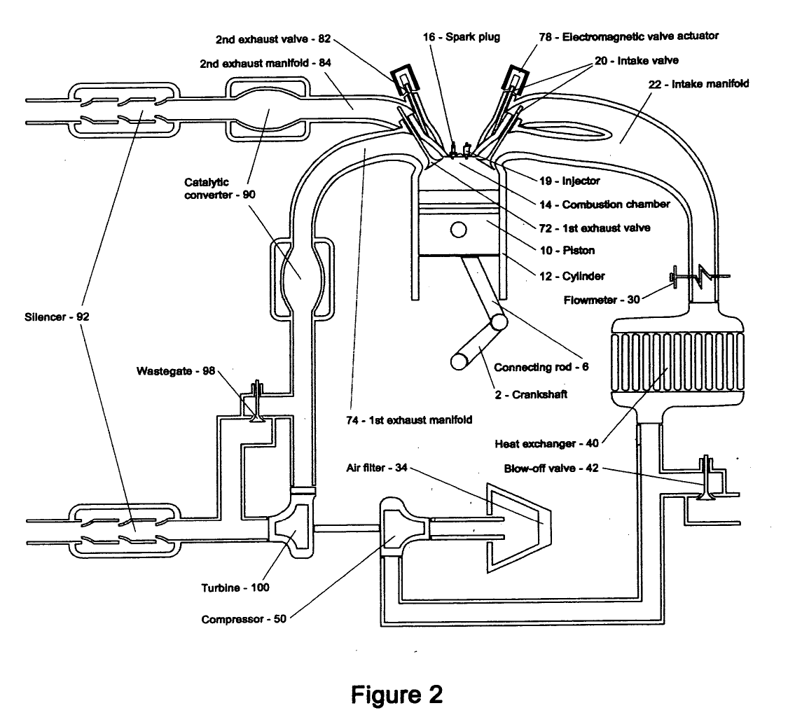

One possible embodiment of the present invention, an improved reciprocating piston, four-stroke spark ignition turbocharged internal combustion engine is schematically shown in FIG. 2. It is equipped with electromagnetic valve actuators (EVA) for all intake and exhaust valves (78), divided exhaust with 1^{st} exhaust valve (72) into 1^{st} exhaust manifold (74) and with 2^{nd} exhaust valve (82) into 2^{nd} exhaust manifold (84), a turbine (100) in the first exhaust path driving compressor (50), an intercooler (40) in the intake path and a direct fuel injector (19) delivering fuel under high pressure inside combustion chamber (14). An air filter (34) prevents dust and debris from getting inside the compressor (50) and damaging the compressor wheel. A blow-off valve (42) relieves excessive pressure from the intake directly into atmosphere or compressor inlet. A flowmeter (30) helps the engine control module determine an appropriate amount of fuel needed to be mixed by the injector (19) with air let in from an intake manifold (22) by an intake valve (20).

On a power stroke, a spark plug (16) ignites combustible mixture inside combustion chamber (14). The rise in pressure acts on a piston (10) that is moved downward inside the cylinder (12) and by means of connecting rod (6) transfers its energy to a crankshaft (2). Exhaust gases are expelled through 1^{st} exhaust valve into 1^{st} exhaust manifold and further through catalytic converter (90) to the turbine (100), where (at high load) part of the exhaust energy is extracted to drive the compressor wheel. Excessive exhaust pressure may be relieved downstream by the wastegate (98) located before the turbine (100). The flow through 1^{st} exhaust path may be dynamically adjusted by distributing the flow between 1^{st} and 2^{nd} exhaust paths. Freer flowing 2^{nd} path, unrestricted by the turbine, may be used later in the cycle to relieve pressure from the cylinder beyond the point that 1^{st} path allows. This lowers cylinder temperature and improves engine's volumetric efficiency. Catalytic converter (90) reduces harmful emissions and silencer (92) at the end of each path keeps noise within acceptable limits.

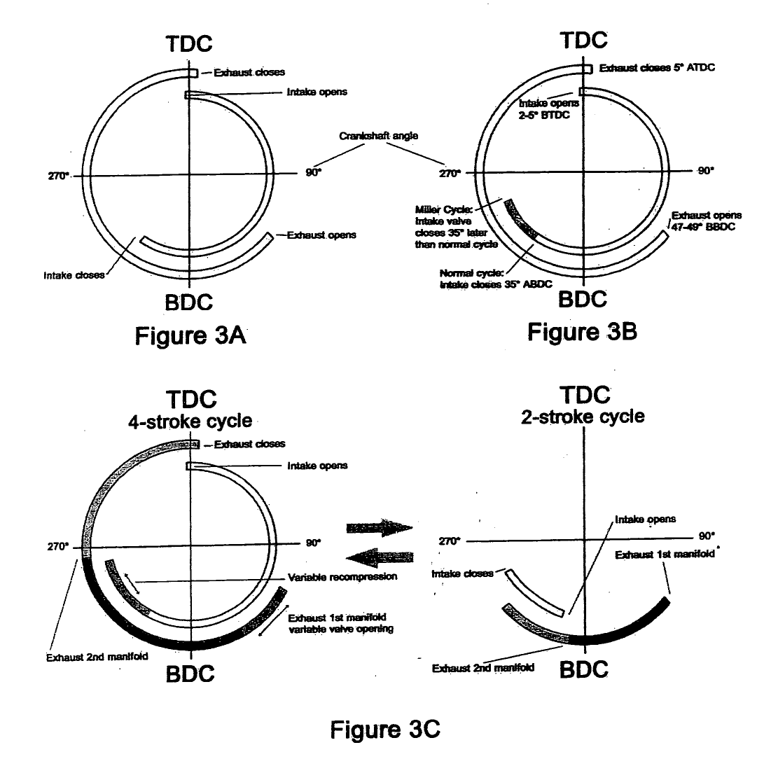

At start, idle and partial load the engine operates in a four-stroke mode shown in FIG. 3C on the left-hand side. Intake opens to let the air in as the piston moves from top dead center (TDC) to bottom dead center (BDC). When the piston changes direction and moves toward TDC, the intake closure may be controlled to regulate engine speed, as well as to control combustion chamber temperatures by decreasing recompression when the amount of heat in intake charge reaches certain level. This may be necessary to prevent detonation while the compressor pressurizes intake air. Upon intake closure the piston further compresses the air, the fuel is introduced inside the cylinder and ignited. Expanding gases act on the piston as it moves toward BDC during power stroke, transferring the energy to the crankshaft. Before BDC is reached first exhaust valve is open into first exhaust manifold. Said valve may be opened sooner to supply more energy to the turbine to essentially eliminate turbo lag and lower boost threshold. When the piston travels back to the TDC, excessive back pressure is relieved later in the cycle through the freer flowing second exhaust path. It is understood that there exists an overlap between first and second exhaust valves, although second exhaust valve remains open (at high load) after first valve is closed. Furthermore, FIG. 3C is used to illustrate succession of events only and does not depict specific angular relationship of valve operation, that may greatly vary for every specific application.

As the power demand exceeds what the engine operating on a four-stroke cycle can supply, the intake pressure is increased to the point, not necessarily beyond what is sufficient for a dynamic switch from a four-stroke cycle to a two-stroke cycle. When the intake air pressure becomes sufficient to displace exhaust in a two-stroke cycle, the engine is converted, by means of variable valve timing, to a two-stroke mode (depicted on the right-hand side of FIG. 3C) to further increase power by doubling the number of putts per revolution.

The cycle starts with a power stroke as the charge burns and drives piston toward BDC. Before BDC is reached, first exhaust valve opens and lets exhaust escape through first exhaust path, where part of its energy is captured by the turbine to pressurize intake air. When the piston travels back toward TDC second exhaust valve opens, first valve closes, so the back pressure is essentially removed from the cylinder through freer flowing second exhaust path. This creates necessary pressure differential for pressurized intake air to drive remaining exhaust out of the cylinder when intake opens later in the cycle. When the exhaust gases are essentially removed from the cylinder during intake valve and second exhaust valve overlap, second exhaust valve is closed. The piston may begin recompression or the closure of the valve may be further delayed to control power output and combustion chamber temperatures. The exhaust gas recirculation may be controlled by varying the degree of exhaust gas removal. As the piston continues its travel toward TDC the charge is being compressed, fuel introduced and ignited during another power stroke to continue the cycle. Direct injection delivers fuel after exhaust valves are closed. This ensures that no unburned combustible mixture is blown-through while exhaust gases are being displaced by pressurized intake air.

The intake air density can be further increased until a predetermined peak cylinder pressure or combustion chamber temperature is reached. At this point the excess compressed air may be expelled through a blow-off valve and the flow through exhaust driven turbine reduced to decrease the degree of pressurization by the compressor.

When the power demand is reduced, the engine reverses itself from a two-stroke cycle to a four-stroke cycle and may shut-off cylinders at low load. This results in a high output and efficiency engine.

The average power use in a conventional vehicle is fairly low relative to maximum power output necessary for adequate acceleration. This becomes an issue, because conventional IC engine is rather inefficient at low loads due to high mechanical friction, heat and pumping losses. Greatly improved power output of the engine of the present invention may allow the use of a much smaller engine (at higher load) and therefore considerably decrease friction, pumping and heat losses, while maintaining adequate acceleration.

To further improve fuel economy a high efficiency low emissions vehicle is proposed, having two ultra small high power and efficiency IC engines (according to this invention) that are capable of moving said vehicle independently from one another, each supplemented by a hybrid adapter capable of regenerative braking and electric torque boost for acceleration, as well as may be used to essentially cancel out fluctuations in torque (and vibration) by applying certain amount of counter torque to the crankshaft (this may allow use of engines with fewer cylinders and therefore reduced cost). Each IC engine/hybrid adapter pair uses continuously variable transmission to transfer power to the independent wheels in such a way, that the vehicle may be moved by (1) one or two electric motors only; (2) electric motor and one IC engine; (3) two electric motors and one engine; (4) one IC engine only; (5) both IC engines; (6) both IC engines and one or two electric motors. Consequently this makes possible to continuously operate ultra small engines at maximum efficiency at any load, while providing adequate acceleration. Despite of twice the number of engines and hybrid units the cost penalty is minor due to small number of cylinders and small size of each engine. This results in superior fuel economy, while acceleration and range of vehicle travel at high load remain fully adequate.

It is claimed:

1. An internal combustion engine, comprising:
a cylinder block defining at least one cylinder; a piston reciprocally movable within said cylinder; a cylinder head which together with said piston and said cylinder defines a combustion chamber;
an intake valve into each cylinder enabling entrance of air into said cylinder;
an exhaust valve from each cylinder enabling exhaust removal from said cylinder;
a valve timing means capable of adjusting valve operation to support a dynamic switch from a four-stroke cycle to a two-stroke cycle at high load, and from a two-stroke cycle to a four-stroke cycle at partial load and idle;
an air compression means capable of pressurizing an intake air to a pressure not necessarily greater than is sufficient to insure its flow into the cylinder after said switch from a four-stroke operation to a two-stroke cycle, where it may be recompressed by the piston before ignition and beginning of the power stroke.

2. An engine of claim 1, wherein the air compressor is at least partially motivated by the exhaust flow.

3. An engine of claim 1, wherein at least one additional exhaust valve is provided, such that divided exhaust flow system can be realized;
a first and a second exhaust manifolds are provided, each connected to a respective exhaust valve;
an air compressor is connected to said first exhaust manifold and is at least partially motivated by the exhaust flow.

4. An engine of claim 3, wherein an operation of exhaust valves at high load is such that high pressure exhaust gases are primarily expelled through said first manifold to facilitate pressurization of the intake air, and a particular state exists later in the cycle when an exhaust valve into second manifold remains open after closure of a valve into first manifold, such that back pressure in the cylinder can be relieved through a freer flowing second manifold.

5. An engine of claim 4, wherein a more restrictive exhaust driven turbine is used in the turbocompressor to extract more energy from exhaust and substantially reduce boost threshold and turbo lag, while increased back pressure is effectively relieved later in the cycle through the second exhaust manifold after the first exhaust manifold is closed.

6. An engine of claim 5, wherein a supercharging means is employed to provide continuous low rotation operation on a 2-stroke cycle.

7. An engine of claim 5, comprising 2 or more cylinders.

8. An engine of claim 7, wherein the cylinder shut-off is employed at low load.

9. An engine of claim 7, wherein direct fuel delivery means are employed.

10. An engine of claim 7, wherein a spark ignition means is employed.

11. A method of an exhaust turbine sizing for a supercharged IC engine where special emphasis is placed upon maximization of power and reduction of boost threshold and turbo lag, while increased back pressure is relieved by means of divided exhaust.

12. A method of valve timing in relation to power demand, that provides a four-stroke cycle engine operation at partial load and idle, and supports alteration of valve action to support a dynamic switch from a four-stroke cycle to a two-stroke cycle at high load. At low load a number of cylinders may be shut-off.

13. An internal combustion engine, comprising:
a cylinder block defining at least one cylinder; a piston reciprocally movable within said cylinder; a cylinder head which together with said piston and said cylinder defines a combustion chamber;
an intake valve into each cylinder enabling entrance of air into said cylinder;
an exhaust valve from each cylinder enabling exhaust removal from said cylinder; at least one additional exhaust valve is provided, such that divided exhaust flow system can be realized;
an air compression means;
a valve timing means capable of adjusting valve operation to support early 1^{st} exhaust manifold opening to provide more exhaust gas energy to the turbine.

14. An engine of claim 13, wherein an operation of exhaust valves at high load is such that high pressure exhaust gases are primarily expelled through said first manifold to facilitate pressurization of the intake air, and a particular state exists later in the cycle when an exhaust valve into second manifold remains open after closure of a valve into first manifold, such that back pressure in the cylinder can be relieved through a freer flowing second manifold.

15. An engine of claim 14, wherein a more restrictive exhaust driven turbine is used in the turbocompressor to extract more energy from exhaust and substantially reduce boost threshold and turbo lag, while increased back pressure is effectively relieved later in the cycle through the second exhaust manifold after the first exhaust manifold is closed.

16. An engine of claim 14, wherein a direct fuel injection is supplemented with a port fuel injection to reduce emission levels that are generally higher with stratified fuel injection.

17. An engine of claim 14, wherein compression is substantially higher to improve efficiency at light loads, while full load detonation is controlled by adjusting recompression, and peak power demand is satisfied in a two stroke mode.

18. A high efficiency low emissions vehicle, comprising:
a vehicle body;
two IC engines connected to said body and capable of moving said vehicle independently from one another at efficiency greater than 30%;
a supercharging means is provided to increase engine's peak power output;
a means for recapturing, accumulating and expending said vehicle's kinetic energy (e.g. electric motor/generator);

19. A vehicle of claim 18, wherein said IC engines have divided exhaust.

20. A vehicle of claim 19, wherein said IC engines are capable of dynamically switching in a two-stroke mode.
